(19) United States
(12) Patent Application Publication
(10) Pub. No.: US 2005/0281713 A1
(43) Pub. Date: Dec. 22, 2005

(54) System and method for sample collection

(75) Inventors: James M. Hampsch, Lafayette, IN (US); Scott R. Peters, West Lafayette, IN (US); Candice B. Kissinger, West Lafayette, IN (US)

Correspondence Address: ICE MILLER, ONE AMERICAN SQUARE, BOX 82001, INDIANAPOLIS, IN, 46282-0200, US

(73) Assignee: Bioanalytical Systems, Inc. (an Indiana company), West Lafayette, IN (US)

(21) Appl. No.: 10/871,923

(22) Filed: Jun. 18, 2004

(51) Int. Cl. B01L 3/00

(52) U.S. Cl. 422/102

(57) ABSTRACT

A tube assembly, system and method for biological waste containment for sample collection, and for ultrafiltration collection. In one embodiment, the tube assembly of the present invention includes a first tube, a second tube, a mechanism for securing the first and second tubes, and at least one container for operable connection to one or both of the first and second tubes. The securing mechanism orients the first ends of the first and second tubes in a manner such that the first end of the first tube extends beyond the first end of the second tube an interstitial space is created between the outer diameter of the first tube and the inner diameter of the second tube. The tubing mechanism is utilized for retrieval of a biological fluid through the first tube, flushing the first tube and the second tube with a rinse solution, and extraction of waste through the second tube into a waste container. The tubing mechanism is also utilized for retrieval of collection samples with the addition of a vacuum source and sealed manifold.

### FIELD OF THE INVENTION

The present invention relates generally to the provision of a tube assembly, system, and method for biological fluids, and, more particularly, to a tube assembly, system, and method for waste containment and sample collection.

### BACKGROUND OF THE INVENTION

In the field of health science, there is often a need to collect multiple biological fluid samples (including blood, urine, spinal fluid, synovial fluid, fermentation broth, etc.) from laboratory animals, human subjects, cell cultures, and fermentations. In some cases, the biological fluid may be hazardous due to the presence of infectious agents or pathogens. In other cases, the biological fluid samples may be radioactive as a result of radioisotopes inserted into the host organism to act as biomarkers. Multiple biological fluid samples are needed in preclinical research with laboratory animals or in human clinical trials to evaluate the efficacy, toxicity, stability, and pharmacokinetics of new pharmaceuticals. Multiple biological fluid samples are also needed in intensive care medicine, to monitor chemical changes that may indicate alterations in the health of the subject or indicate a need to alter a prescribed treatment, and in fermentation, to indicate changing concentrations of toxic and non-toxic agents. Such samples are collected periodically, for example, at points that are separated in time or at points based on condition(s) in order to monitor the temporal changes of the biological fluid in the subject, cell culture, or fermentation. It is important, in such a context, to avoid contamination of a current biological fluid sample with biological fluid from previous sample collections. The collection and storage of multiple biological fluid samples in individual collection vessels is labor-intensive, time-consuming, and can be difficult to accomplish if fluid samples are needed from multiple subjects at the same time.

Frequently, in the prior art, systems have been designed for the automated collection of biological fluid samples into individual collection vessels. Some of these systems function by moving a new collection vessel below a stationary dispensing needle for each sample collection, whereas other systems function by moving a dispensing needle above a stationary rack of individual collection vessels for each sample collection. In either type of system, the collection vessels are located in close physical proximity to the dispensing needle, and are often supported within a refrigerated environment or located in close physical proximity to an animal subject, i.e., situations that involve limited space.

In cases where it is desired to dispense the biological samples into sealed collection vessels, the dispensing needle in the automated sample collection system is moved down to pierce a septum in the collection vessel. A mechanism is provided to allow displaced air within the sealed collection vessel to escape as the vessel is being filled with the biological fluid sample. After the biological fluid sample is dispensed into the collection vessel, the needle is moved up and out of the collection vessel and the septum reseals the collection vessel. In these automated sample collection systems, the dispensing needle and tubing leading to the dispensing needle are flushed with a rinse solution between every biological fluid sample collection, with the resulting biological fluid waste being flushed out of the end of the dispensing needle. Flushing is performed to remove biological fluid remaining inside the dispensing needle and the tubing leading to the dispensing needle that might otherwise contaminate the subsequent biological fluid sample with biological fluid remaining from the previous biological fluid sample.

The outside of the dispensing needle is also flushed with a rinse solution between every biological sample collection. Since the dispensing needle is suspended within the sealed collection vessel while dispensing the biological fluid sample, the outside surface of the dispensing needle is in contact with the fluid sample. Some of the biological fluid sample may adhere to the outside of the dispensing needle. Any biological fluid that does adhere to the outside of the dispensing needle may contaminate the subsequent biological fluid sample when the needle dispenses the next biological fluid sample into the next collection vessel. Flushing the outside of the dispensing needle with rinse solution requires a means of moving the rinse solution to the outside of the dispensing needle, at appropriate times, and stopping rinse flow when not needed; this typically requires pumps, valves, tubing and/or software control, all of which add to the complexity and cost of the automated sample collection system.

The volume of rinse solution necessary to thoroughly flush the inside and the outside of the dispensing needle, and the tubing leading to the dispensing needle, is typically many times the volume contained within the needle and the tubing. Because flushing the dispensing needle and the tubing leading to the dispensing needle occurs between every biological fluid sample collection, a total volume of biological fluid waste is generated that is much greater than the volume of a sample collection vessel. During the flushing process, the rinse solution mixes with the residual biological fluid located inside and on the outside of the dispensing needle, and within the tubing leading to the dispensing needle. If the residual biological fluid is hazardous due to the presence of radioisotopes, infectious agents, pathogens, or other risks, then the resulting biological fluid waste, consisting of residual biological fluid and rinse solution, must be treated as hazardous waste as well.

In automated sample collection systems known in the prior art in which the dispensing needle and the tubing connected to the dispensing needle are flushed with rinse solution to remove residual biological fluid, the resulting biological fluid waste exiting from the end of the dispensing needle, and the waste generated by flushing the outside of the dispensing needle, are collected in an open, reusable, i.e., cleanable, collection vessel or vessels. The use of such a collection vessel or vessels maximizes an operator's exposure to hazardous or potentially hazardous biological fluid waste, not only by virtue of the biological fluid waste being a hazard in and of itself to an operator, but also by virtue of any surface having contact with biological fluid waste being a source of hazard to an operator. Operator exposure to contaminated surfaces may occur during the collection of biological fluid waste in an open, cleanable collection vessel, or may occur following the collection process during operator cleaning and disinfecting of the surfaces of the collection vessel that were exposed to biological fluid waste, and even through contact with surfaces that have been previously cleaned and disinfected.

Preparing an automated sample collection system for new sample collections, by cleaning and disinfecting surfaces of a collection vessel or vessels previously exposed to biological fluid waste, requires the expenditure of time and labor and can be tedious, the result of which is that surfaces exposed to biological fluid waste are not always cleaned or are not cleaned thoroughly. Biological fluids are a rich medium for vigorous microbial growth. In cases where biological fluid waste is not adequately removed by cleaning and is allowed to collect, the resulting microbial growth can obstruct fluid flow paths in the collection system, which may cause fluid to accumulate. Fluid accumulation due to obstruction from microbial growth may ultimately cause collection system instrument failures. In cases where surfaces of the automated sample collection system that are exposed to biological fluid waste are thoroughly cleaned, the cleaning process itself can expose collection system instruments to cleaning solvents and physical cleaning action that may be harmful to the instruments and detrimental to proper operation. Cleaning solvents spilled into areas of the collection system that are not intended for exposure to such chemicals may result in damage to those areas. Furthermore, cleaning solvents are often incompatible with label adhesives, which may be dissolved at inopportune times with unforeseen consequences.

Therefore, in order to overcome the aforementioned disadvantages inherent in the prior art, it is desirable that a collection vessel for biological fluid waste, associated with an automated sample collection system, be sealed, self-contained, and disposable so that potential contact with contaminated surfaces on the part of an operator is minimized and cleaning or disinfecting of contaminated surfaces is not required.

It is also desirable that a biological fluid waste collection vessel accommodate a much greater fluid volume than that of a sample collection vessel, while avoiding the necessity that such a waste collection vessel is located in close physical proximity to individual sample collection vessels, and the necessity that a dispensing needle moves automatically, to the location of such a waste collection vessel in order to dispense biological fluid waste. Such automated movement would require drive components and control software, add significantly to the complexity, size, and expense of the automated sample collection system, and reduce both its utility and its reliability.

Accordingly, it is desirable to provide a system and method of biological fluid waste collection for sample collection that offers:
Compatibility with automated sample collection systems in which sample collection vessels are moved under a stationary dispensing needle, or in which a dispensing needle moves above a stationary rack of individual collection vessels, the collection vessels of which are located in a refrigerated or non-refrigerated environment;
The ability to be used without automated sample collection systems;
Sealed, self-contained, and disposable containment of biological fluid waste;
Large volume containment of biological fluid waste;
Flushing of the inside and outside surface of a dispensing needle, as well as the entire sample flow path; and
Simple, reliable, and inexpensive implementation.

Ultrafiltration is a membrane sampling technique for extracting biological fluids from probes implanted in a subject. Sample collection from ultrafiltration probes generally requires the use of a vacuum. The vacuum is used to force the fluid surrounding the probe to pass through pores in the semi-permeable membrane that filters out macromolecules. The filtered sampled fluid travels through tubing and is deposited into a collection vessel in a continuous flow process. Often the flow is fractionated or collected into multiple discrete samples in separate collection vials, with each such sample representing time periods across which the samples are collected.

In the prior art, the vacuum source used to draw the fluid through the membrane, through the tubing, into the collection vial may be provided in the collection vial itself. This is accomplished using a vacutainer. A vacutainer is an evacuated test tube having rubber stopper cap. The tubing from the probe is connected to a needle and the needle is inserted through the rubber stopper into the vacutainer. The vacuum in the sealed vial causes the fluid to filter through the probe membrane and be drawn into the vial.

Systems using vacutainers have several shortcomings. Vacutainers are unsuited for drawing small volume samples, such as is typical samples taken from small rodents, because it is difficult to remove the small sample from the relatively large vacutainer vial. Thus, a large proportion of sample may be left in the vacutainer when extracting the sample for analysis. Sample volumes may be as small as 10 uL and the smallest commercially available vacutainer holds 5000 uL volume. Also, vacutainers do not provide an indication of the level of vacuum within. Leakage through system, including leakage around the stopper, reduces the vacuum to an unknown level. In some cases, leakage may essentially result in no vacuum. Due to the relatively low flow rate of such systems, a loss of vacuum may not be discovered for some time and time sensitive samples may be lost.

The vacuum level in ultrafiltration systems is one factor that determines the rate and volume of sample collection. If ultrafiltration is used to assess changes in the availability of fluid from a particular probe location, the flow from the probe should be as consistent as possible. Vacutainers cannot assure consistent vacuum, and, therefore, cannot assure consistent flow from the probe. Further, when collecting multiple samples, vacutainers must be substituted by hand. Manual operation requires someone to be present at each time point of collection. Thus, these vacutainers are not suited for automated small volume fraction collection.

Peristaltic pumps have also been used in prior art systems as the vacuum source for the probe membrane and to move the filtered fluid from the probe to the collection vial. The pump is generally located between the probe and the collection vial. Such location of the pump allows automated fraction collection of multiple ultrafiltrate samples into refrigerated collection vials. However, this approach requires the ultrafiltrate to pass through peristaltic tubing on the way to the vial. Peristaltic tubing generally contains a relatively large volume, and large volume increases the time required for the fluid to move from the probe to the collection vial. Thus, a significant time lag results for the low flow rates associated with ultrafiltration in small rodents. Also, peristaltic tubing is formulated to be soft and pliable and have good compression characteristics. However, the plasticizing chemicals used to produce these characteristics can contaminate the fluid washing through the tube. Such contamination can create a significant interference in the assay of the analyte in the ultrafiltrate. Analyte from the ultrafiltrate may also bind to this tubing making it unavailable for analysis, and thus altering the measured concentration of analyte in the collected sample. Further, the flow characteristics from peristaltic pumps change over time as the tubing stretches from the compression of the pump rollers. This change in flow characteristics creates inconsistent flow over time and introduces uncertainty as to whether changes in flow are due to physiological factors in the subject or due to the pump and tubing.

Thus, it is desired to provide a system and method for sample collection that:
Is suitable for use in drawing small volume samples;
Permit for control of the vacuum, even if leakages exists in the system;
Permit for control of the flow of fluid from the probe;
Do not require human intervention for the collection of multiple samples;
Do not require the use of tubing of large volume or otherwise result in a time lag for flow rates;
Do not require the use of tubing that may contaminate the fluid washing through the tube;
Do not require the use of tubing that binds the analyte in the sample fluid washing through the tube;
Utilize tubing having constant or predictable flow characteristics; and
Provides for consistent flow over time.
   It is further desired that the system and method provide for collection of ultrafiltration collection manually, or with existing automated collection systems.

### SUMMARY OF THE INVENTION

The present invention comprises a tube assembly, system, and method for waste containment when collecting biological samples or rinsing collection systems. In one embodiment, the tube assembly of the present invention includes a first tube, a second tube, a mechanism for securing the first and second tubes, and at least one container for operable connection to one or both of the first and second tubes. The securing mechanism comprises a threaded hub having a cavity, and with adhesive cured in the cavity. The securing mechanism is operable to orient the first and second tubes such that the first end of the first tube extends beyond the first end of the second tube. Further, the first end of the second tube has an inner diameter greater than the outer diameter of the first tube to create an interstitial space about the first tube at the first end of the second tube.

The tube assembly of the present invention can be used for biological fluid sample collection and for rinsing, and results in containment of waste resulting from both processes. For collection of a biological sample, the tube assembly is connected to a source of a biological fluid sample through the second end of the first tube. Connected to the second end of the second tube is a container for receipt of waste. For collection of the biological waste, the tube assembly is inserted into a collection vial having a septum. Specifically, the first tube is inserted through the septum so that the opening of the first end of the first tube resides within the interior of the collection vial and near the bottom of the vial, and such that the first end of the second tube is inserted through the septum so that the open first end resides within the interior of the collection vial near the top of the vial. This orientation results in the septum sealingly engaging the exterior of the second tube.

During operation, the fluid sample is caused to move from the second end of the first tube through the opening of the first end of the first tube into the collection vial. The contents originally residing in the collection vial, such as air, that is displaced by the biological sample deposited into the collection container travels into the interstitial space between the first and second tubes. The displaced contents of the vial then travel to the waste container. Thus, the waste container collects air displaced by the biological sample. Such air is tainted by the biological sample.

To rinse the tube assembly, a source of a rinse solution is operably connected to the second end of the first tube. The second end of the second tube is connected to a container for receipt of waste. For collection of biological sample, the tube assembly is inserted into a rinse vial containing rinse solution and having a septum. Specifically, the first tube is inserted through the septum of the rinse vial so that the opening of the first end of the first tube resides within the interior of the rinse vial and near the bottom of the vial, and such that the first end of the second tube is inserted through the septum so that the opening of the first end of the second but resides within the interior of the rinse vial near the top of the vial. The septum sealingly engages the exterior surface of the second tube.

During operation, the rinse solution is caused to move from the second end of the first tube through the opening of the first end of the first tube into the rinse vial displacing biological waste residing in the first tube into the rinse vial. Rinse solution, or other original contents of the rinse solution, that is displaced by biological waste fluid deposited into the collection container travels into the interstitial space between the first and second tubes. The displaced contents of the rinse vial then travel to the waste container. Thus, the waste container collects the contents of the rinse vial displaced by the biological waste fluid. Such contents are tainted by the biological sample residing in the rinse vial.

Continued provision of rinse solution into the rinse vial will eventually flush biological waste in the rinse vial through the interstitial space between the first and second tubes to the waste container. Any additional rinse solution will flow through the rinse vial, the exterior of the first tube and into the interstitial space, for subsequent deposit in the waste container. This results in rinsing of the interior and exterior of the first tube and interior of the second tube of any biological sample residing thereon or therein.

According to one embodiment, the ultrafiltration collection system of the present invention comprises a tube assembly as previously described. The system also includes a probe operatively connected to the second end of the first tube of the tube assembly, a trap operatively connected to the second end of the second tube of the tube assembly, and a vacuum source operatively connected to the trap. The system may also include a first container for collection of the ultrafiltration sample from the probe, the first container for connection to the tube assembly such that the first end of the first tube of the tube assembly and the first end of the second tube of the tube assembly reside within the interior of the first container. This first container may comprise a vial, with, or without a septum thereon.

One embodiment of the method of collecting a sample according to the present invention requires provision of a system as described above. The method also comprises the steps of inserting the tube assembly into the first container, activating the vacuum source to cause air to withdraw from the first container through the second tube of the tube assembly and the trap. Then, the sample is pulled through the first tube of the tube assembly into the first container.

The present invention obviates or mitigates at least one disadvantage of previous systems and methods. The tube assembly of the present invention may be used manually or with automated sample collection systems. In fact, the tube assembly may be easily integrated with existing collection systems. The system and method permit for containment of waste of fluids—both gases and liquids—that may be tainted with a biological sample during a sampling process or during the rinsing process. Collection and containment of such waste results in a safer environment, as well as improved environmental and control conditions for sample collection. The present invention results in sealed, self-contained, and disposable containment of fluid waste, and also permits for large volume containment of such waste. All surfaces of a needle assembly used in depositing a biological sample for collection can be rinsed according to the system and method of the present invention. Both the inside and outside of the needle and the inside of the cannula may be flushed and the waste collected therefrom contained. The apparati of the present invention is also comprised of simple, reliable, inexpensive components, and the methods of the present invention are retrofittable and simple to implement.

The system and method of the present invention used for ultrafiltration collection addresses several of the shortcomings of the prior art. The present invention is suitable for use in drawing small volume samples, and provides for consistent flow over time. The tubing used in the present invention is of appropriate volume, does not contaminate the fluid washing through the tube and has predictable flow characteristics. The present invention permits for control of the vacuum, control of the flow of fluid from the probe, and does not require human intervention for the collection of multiple samples. The ultrafiltration collection system and method may be accomplished manually, or may be retrofitted into existing automated collection systems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures, wherein:

FIG. 1 shows a diagrammatic view of one embodiment of the system of the present invention;

FIG. 2 shows a cross-sectional view of one embodiment of the tube assembly of the present invention;

FIG. 3 shows a cross-sectional view of one embodiment of the mechanism for securing the first ends of the first and second tubes according to the present invention;

FIG. 4 shows a diagrammatic view of one embodiment of an automated system according to the present invention;

FIG. 5 shows a partial cross-sectional view of one embodiment of the tube assembly of the present invention inserted into a collection vial; and

FIG. 6 shows a diagrammatic view of another embodiment of the system of the present invention.

### DETAILED DESCRIPTION

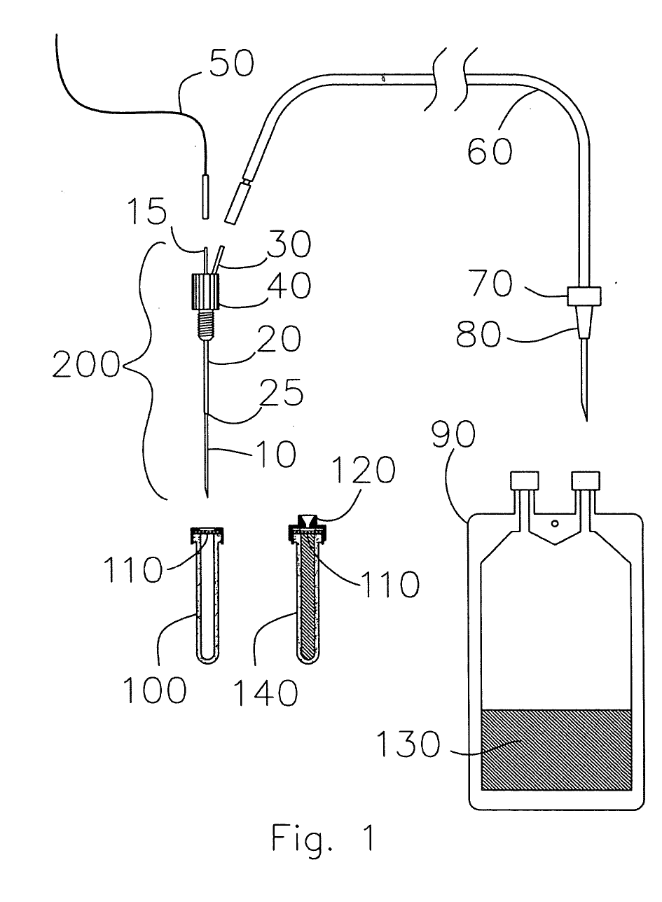

Generally, the present invention provides a tubing assembly, system, and method for biological fluid waste containment for sample collection. Referring now to FIG. 1, there is shown a diagrammatic view of one embodiment of the system of the present invention. Specifically, FIG. 1 shows one embodiment of tube assembly 200 that can be used manually or with an automated sample collection system, as is explained in greater detail herein. Tube assembly 200 of FIG. 1 dispenses biological fluid samples into sealed collection vial 100. In addition to collection vial 100, tube assembly 200 can be inserted into rinse vial 140. In this embodiment, each of vials 100 and 140 comprise septum 110 that seals the vial. Rinse vial 140 also comprises guide cap 120.

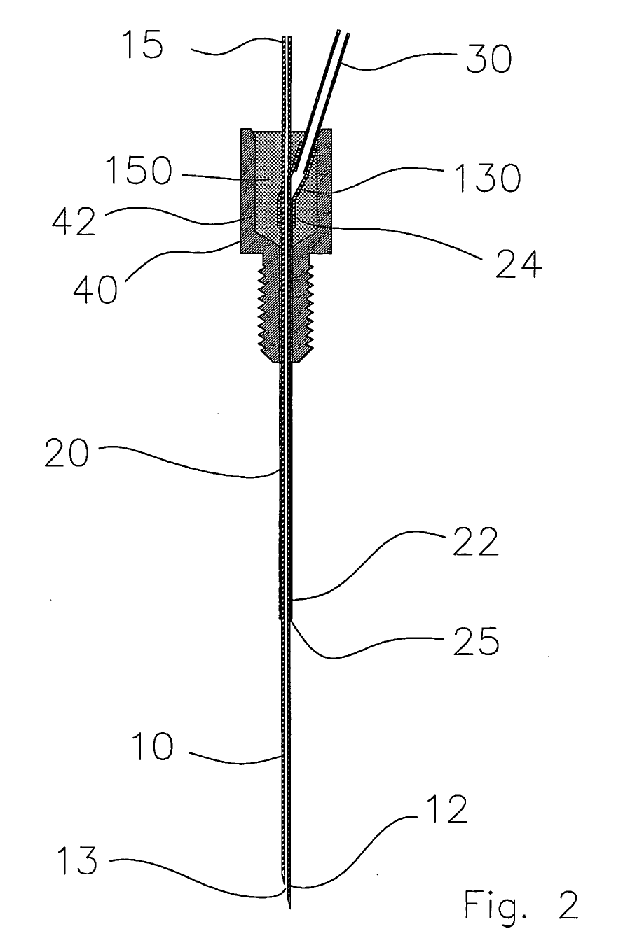

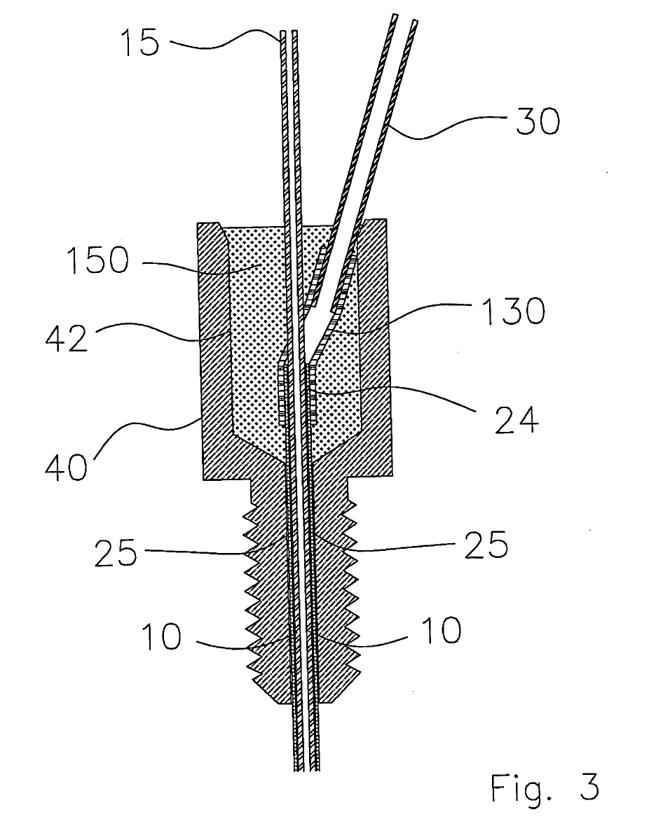

In the embodiment of FIG. 1, tube assembly 200 includes rigid cannula 20 placed over the outside of needle 10 so that there is clearance between the interior of the cannula 20 and the outside of the needle 10, as is explained in greater detail in association with FIG. 2 and FIG. 3 hereof. The clearance, interstitial space, between the inside of cannula 20 and the outside of needle 10 permits displaced air or liquid from vials 100 and 140 to escape into this interstitial space.

FIG. 2 shows a cross-sectional view of one embodiment of the tube assembly of the present invention, and FIG. 3 shows a cross-sectional view of one embodiment of the mechanism for securing the first ends of the first and second tubes according to the present invention. Needle 10 has first end 12 and second end 15. First end 12 includes aperture or opening 13. Cannula 20 includes first end 22 and second end 24. First end 22 of cannula 20 includes an opening through which first end 12 of needle 10 extends, and first end 22 of cannula 20 has a diameter greater than the diameter of first end 12 of needle 10. This orientation of needle 10 and cannula 20 create interstitial space 25 at first end 22 of cannula 20 about needle 10.

To obtain the aforementioned orientation, tube assembly 200 of FIG. 1, FIG. 2, and FIG. 3 also includes a mechanism for securing cannula 20 to needle 10. This securing mechanism comprises threaded hub 40 having cavity 42. The securing mechanism further includes adhesive 150 cured within cavity 42.

In the embodiment of FIG. 2 and FIG. 3, also shown is short flexible polymer tube 130 press fit over second end 24 of cannula 20. The other end of the flexible polymer tube 130 is press fit over an end of rigid exit tube 30. Needle 10 pierces through one sidewall of flexible polymer tube 130 and extends inside the lumen of flexible tube 130, inside the lumen of outer cannula 20, and extends beyond the bottom of outer cannula 20. The assembly consisting of flexible tube 130, first end 24 of outer cannula 20, an end of exit tube 30, and a portion of needle 10 are all placed within cavity 42 of threaded hub 40 and fixed into place by adhesive 150. First end 12 of needle 10 and first end 22 of outer cannula 20 extend out the bottom of threaded hub 40. Second end 15 of needle 10 and the distal end of exit tube 30 extend out the top of threaded hub 40.

As previously stated, in the embodiment of FIG. 2 and FIG. 3, cavity 42 is filled with adhesive 150. Adhesive seals all fluid connections and secures all components to threaded hub 40. The combination of threaded hub 40, cavity 42, and adhesive 150 also serve to orient needle 10 and cannula 20 in the manner shown, and to create interstitial space 25. In this way, a contiguous sealed fluid connection is made from the interstitial space 25 between needle 10 and outer cannula 20 through the flexible tube 130 and through rigid exit tube 30.

It will be appreciated by those of skill in the art that other mechanisms for securing needle 10 and cannula 20 to create interstitial space 25 may be used. For example, needle 10 and cannula 20 may be secured by the material of the threaded hub as the threaded hub is injection molded around the pre-aligned needle and cannula. In addition, it is possible that a single material may comprise cannula 20 and flexible tube 130, and/or exit tube 30. In such an embodiment, cannula 20, flexible tube 130, and exit tube 30 may be comprised of a semi-rigid material, for example, PEEK (polyetheretherketone) tubing.

Based on the illustrations of FIG. 1, FIG. 2, and FIG. 3, it may be simply stated that tube assembly 200 comprises a first tube, a second tube, and a mechanism for securing the first tube to the second tube and create an interstitial space. The first tube comprises needle 10, the second tube comprises cannula 20, and the securing mechanism comprises threaded hub 40 having cavity 42 therein, with cavity 42 having adhesive 150 cured therein. The securing mechanism secures first end 12 of first tube 10 and first end 22 of second tube 20 such that first end 12 of first tube 10 extends beyond first end 22 of second tube 20, with first end 12 of first tube 10 inside first end 22 of second tube 20 creating interstitial space 25 about first tube 10 at first end 22 of second tube 20.

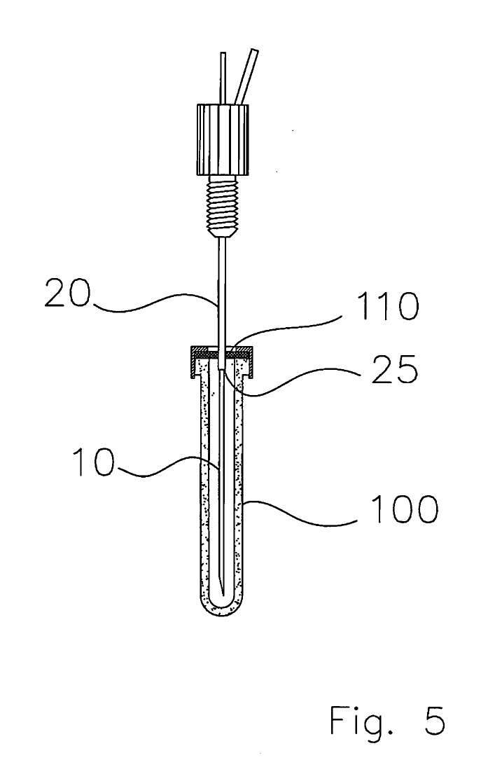

This orientation of tube assembly 200 is explained in greater detail in association with FIG. 5. FIG. 5 shows a partial cross-sectional view of one embodiment of tube assembly 200 inserted into collection vial 100. As shown in FIG. 5, needle 10 has been inserted through septum 100 to reside within the interior of vial 100. The opening at first end 12 of needle 10 is positioned proximate the bottom of the interior of vial 100. Cannula 20 is also inserted through septum 110 such that the first end 22 of cannula 20 resides within the interior of vial 100. The opening of first end 22 of cannula 20 is positioned proximate the top of the interior of vial 100. Septum 110 are cannula 20 are sealingly engaged. Specifically, a seal is formed in septum 110 around the exterior surface of cannula 20 as shown.

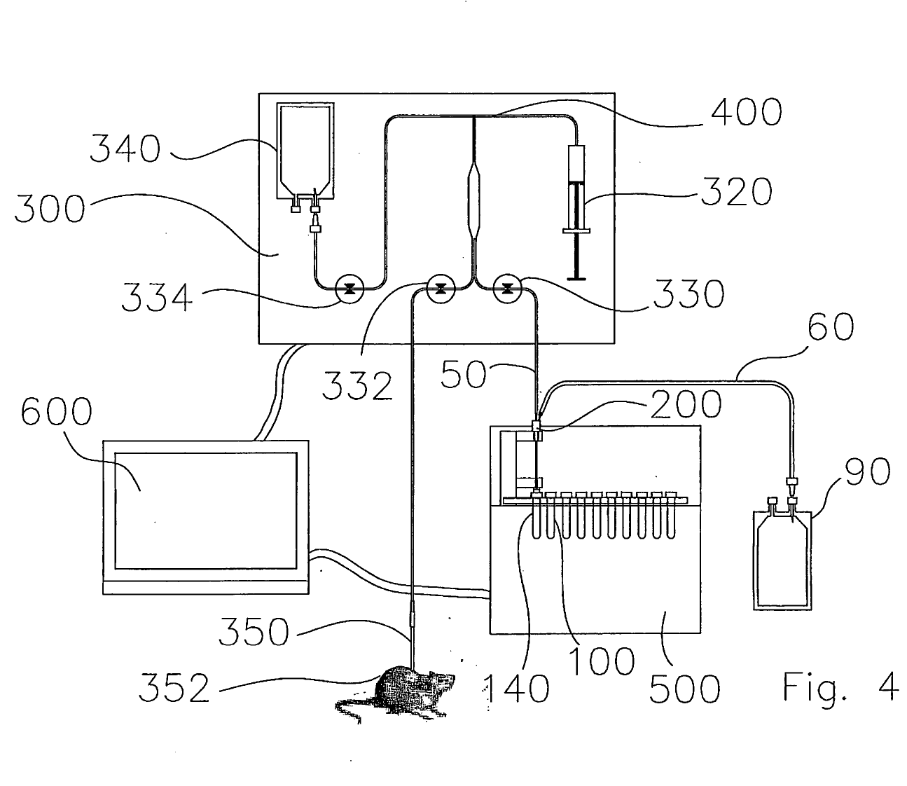

Referring again to FIG. 1, as previously described, the top of cannula 20 is joined to rigid exit tube 30 that angles away from the needle 10 and cannula 20. The connection formed between cannula 20 and exit tube 30 is liquid tight so that displaced air from the collection vial 100 or displaced fluid from the rinse vial 140 can pass from cannula 20 to exit tube 30. Dispensing needle 10, outer cannula 20, and exit tube 30 are all supported within a threaded hub 40, that can be mounted to an automated sample collection instrument as discussed in association with FIG. 4. Exit tube 30 is also connected to one end of flexible tubing 60. The other end of tubing 60 is connected to a luer fitting 70 and a luer hub needle 80. Luer hub needle 80 is inserted into a large sealed waste collection vessel 90 (i.e. an inverted empty intravenous bag) that is located in a position that prevents back flow through tubing 60. Flexible tubing 60 is sized large enough so that there is a minimal resistance to flow through it into the waste collection vessel 90.

Needle 10 includes second end 15 for operable connection of needle 10 to flexible tubing 50. Tubing 50 is operable for connection to the source of the biological fluid and to the source of a rinse solution. This allows a biological fluid sample to pass through needle 10 into collection vial 100 or a rinse solution to pass through the needle into vial 140.

During one embodiment of the sample collection process according to the present invention, a sample is taken through tubing 50 operably connected to a source of the sample (not shown). The sample is introduced to tube assembly 200 via tubing 50. Then, sample collection vessel 100 is moved under dispensing tube assembly 200 (or tube assembly 200 is moved over sample collection vessel 100). Dispensing tube assembly 200 is moved downward (or sample collection vessel 100 is moved upward) to allow first end 12 of needle 10 to pierce septum 110 of sample collection vial 100 and reside within the interior of collection vial 100 near the bottom of vial 100, and first end 22 of cannula 20 pierces septum 110 so that first end 22 resides within the interior of collection vial 100 near the top of vial 100. Septum 110 sealingly engages the exterior surface of cannula 20. The biological sample is then disbursed into sealed vial 100 and any air from vial 100 displaced by the introduction of the biological sample into vial 100 escapes out of sealed vial 100 about first tube 10, into first end 22 of cannula 20, and through the interstitial space 25 between needle 10 and cannula 20. This escaped air travels through exit tube 30 into connecting flexible tubing 60 and ultimately into waste collection vessel 90. Allowing air to escape sealed collection vial 100 during sample collection prevents pressure from building within collection vial 100 as it fills, and thus permits more accurate volume collection of the biological sample. The displaced air is also tainted with the biological fluid, and thus, the contaminated air is collected rather than being permitted to enter the environment.

Dispensing needle assemblies similar to that of the present invention are commonly used in many automated sample collection systems to permit air to escape from sealed vials as they are filled. However, normally, the air from the vial escapes through the cannula to the atmosphere and is not captured by a waste collection vessel. Thus, any contaminants present in the escaped air are allowed to pass into the laboratory atmosphere, exposing operators, others, and equipment to the contaminated air.

After the biological sample has been dispensed into collection vial 100, dispensing tube assembly 200 is raised out of vial 100 (or vial 100 is lowered away from tube assembly 200), and septum 110 seals the biological fluid sample within vial 100. Rinse vial 140 is then brought under the dispensing tube assembly 200 (or tube assembly 200 is brought over rinse vial 140). Dispensing tube assembly 200 is brought down into sealed rinse vial 140 filled with a rinse solution (or rinse vial 140 is brought upward to tube assembly 200) so that opening 13 is inserted through septum 110 of rinse vial 140 into the interior of rinse vial 140, and such that first end 22 of cannula 20 is inserted through septum 110 so that the opening of first end 22 of cannula 20 resides within the interior of vial 140 near the top of vial 140. Septum 110 sealingly engages with the exterior surface of cannula 20. Tubing 50 is flushed with a sufficient amount of rinse solution as extracted through tubing 50 from a rinse solution source operably connected to tubing 50 (not shown). The rinse solution washes the inside of tubing 50 and the inside of needle 10 free of biological fluid waste into rinse vial 110. As rinse solution flows into rinse vial 140, the outside of needle 10 is washed, and any biological fluid adhering to needle 10 will be removed with the rinse solution. The addition of more rinse solution will displace the fluid mixture of biological waste and rinse solution out of rinse vial 140 through interstitial space 25 between needle 10 and outer cannula 20, through exit tube 30, through the connecting tubing 60, and ultimately into the waste collection vessel 90. The flushing of tubing 50 and dispensing tube assembly 200 continues until all the biological fluid waste is removed.

Since septum 110 of rinse vial 140 is pierced by the dispensing tube assembly 200 after each biological fluid sample is collected and must remain liquid tight, guide cap 120 is affixed to septum 110 to assure that the dispensing tube assembly 200 always pierces the rinse vial septum 110 in the same location. Use of the same location helps assure the septum 110 seals around the dispensing outer cannula 20 of tube assembly 200 every time.

FIG. 4 shows a diagrammatic view of one embodiment of an automated system according to the present invention. Waste containment components may be used in automated sample collection systems, such as automated blood sampler that is a system of instruments that work together to:

1. Remove blood from an intravenous catheter implanted in a mammal at programmed intervals

2. Dispense a portion of the blood into sealed refrigerated (3° C.) vials

3. Return the remaining blood to the subject

4. Return sterile saline to the subject to compensate for the blood removed

5. Dispense an optional dilution volume of saline to the collected blood

6. Flush the system with saline prior to the next sample.

An example of such a blood sampling system is disclosed in U.S. Pat. No. 6,062,224, which is incorporated herein by reference.

The automated blood sampler of the embodiment of FIG. 4 consists of control system 300 that incorporates syringe pump 320 for drawing and dispensing the blood (biological sample) and saline (rinse solution). First, second, and third pinch valves 330, 332, and 334, respectively, as part of control system 300 are used to direct fluid (sample or rinse) to the desired location. Tubing set 400 of control system 300 comprises tubing lines inserted into pinch valves 330, 332, and 334. Tubing set 400 connects a syringe mounted on syringe pump 320, saline reservoir 340, intravenous catheter 350 implanted in subject 352, and dispensing needle assembly 200 mounted on fraction collector 500. Fraction collector 500 supports collection vials 100 in a refrigerated environment, moves the desired collection vial 100 under dispensing needle assembly 200, and moves needle assembly 200 down to pierce the septum of collection vial 100. In this embodiment, computer 600 is operatively connected to control system 300 and fraction collector 500, directs the operation of the various instruments, and provides an interface for defining volumes and collection times of the blood samples.

Tube assembly 200 mounted on fraction collector 500 is connected by tubing 50 to tubing set 400 of control system 300. Like collection vials 100, rinse vial(s) 140 is(are) held in fraction collector 500 alongside collection vials 100. Flexible tubing 60 connects to exit tube 30 of needle assembly 200 and extends to waste collection vessel 90 that is mounted external to fraction collector 500. Fraction collector 500 includes a mechanism for orienting tube assembly 200 with respect to collection vials 100 and rinse vial(s) 140. As is well known in the art, such mechanism may comprise robotics to move tube assembly 200 and/or the rack(s) holding collection vial(s) 100 and rinse vial(s) 140.

During operation, a sample of blood is withdrawn from subject 350 as described in U.S. Pat. No. 6,062,224. The connection of tubing set 400 to tubing 50 allows the sample to enter tube assembly 200 mounted on fraction collector 500. Collection vial 100 is caused to move under tube assembly 200 and tube assembly 200 is caused to move downward. When moved downward, needle 10 pierces septum 110 of collection vial 100 and first end 22 of cannula 20 pierces septum 110 of collection vial 100. Septum 110 of collection vial 100 forms a seal around the outside of cannula 20. Movement of the sample, initiated by control system 300, into collection vial 100 caused displaced air from collection vial 100 to move through interstitial space 25 through tubing 60 into waste containment container 90.

After the sample collection in collection vial 100 is complete, tube assembly 200 is raised by fraction collector 500 out of collection vial 100, moved over rinse vial 140, and moved downward to allow needle 10 and first end 22 of cannula 20 to enter rinse vial 140 through septum 110 of rinse vial 140 and to allow cannula 20 to form a seal with septum 110 of rinse vial 100. The system is now in position to be rinsed.

As described in U.S. Pat. No. 6,062,224, rinse solution, saline, is caused to move from saline reservoir through tubing set 400. The connection of tubing set 400 to tubing 50 causes saline to wash the inside of tubing 50 and the inside of needle 10. The saline enters rinse vial 140 through needle 10. Rinse fluid moved into tubing 50 from control system 300 displaces fluid mixture of biological waste and rinse fluid in rinse vial 40 through interstitial space 25, through tubing 60, into waste container 90. This flushing can continue until all biological fluid waste has been removed from tube assembly 200, and from the blood sampling system.

In the operation described for the system of FIG. 4, the orienting mechanism of fraction collector 500 moves tube assembly 200. It will be appreciated by those of skill in the art that the orienting mechanism may move tube assembly 200 and/or vials 100 and 140 and be within the scope of the invention. In essence, the orienting mechanism must be capable of inserting opening 13 of needle 10 and first end 22 of cannula 20 through septum 110 into the interior of the vial and allow septum 110 to seal around the outside surface of cannula 20.

One skilled in the art will recognize that collection vials used with waste collection according to the present invention do not have to be septum sealed provided leakage of air tainted with sample is acceptable. Often such leakage is acceptable, such as when collecting blood samples. If no septum is present, one may chose to use plastic caps, rather than a septum, on the collection vials. However, one skilled in the art will also recognize that the rinse vial used in waste containment according to the present invention should be septum sealed and this seal should be fluid-tight for every sample collected. Thus, it is often desired to provide a guide cap on the rinse vial to assure reliable sealing with the cannula every time the tube assembly is inserted into the rinse vial.

It will be appreciated by those of skill in the art that the tubing set, system, and method of the present invention has many salient features and advantages when compared to the prior art. First, the tubing set and system are useful manually or with existing automated sample collection systems. The invention results in sealed, self-contained, and disposable containment of biological fluid waste. Contaminated air is even captured with the present invention. The invention permits also for large volume containment of biological fluid waste.

It will be further appreciated that the present invention allows for cleaning of all surfaces that may come in contact with biological fluid. The inside and outside of the needle and the inside of the cannula are flushed. These features and advantages are all accomplished with simple, reliable, inexpensive components that are retrofitable with existing collection systems, and with straightforward, inexpensive methods.

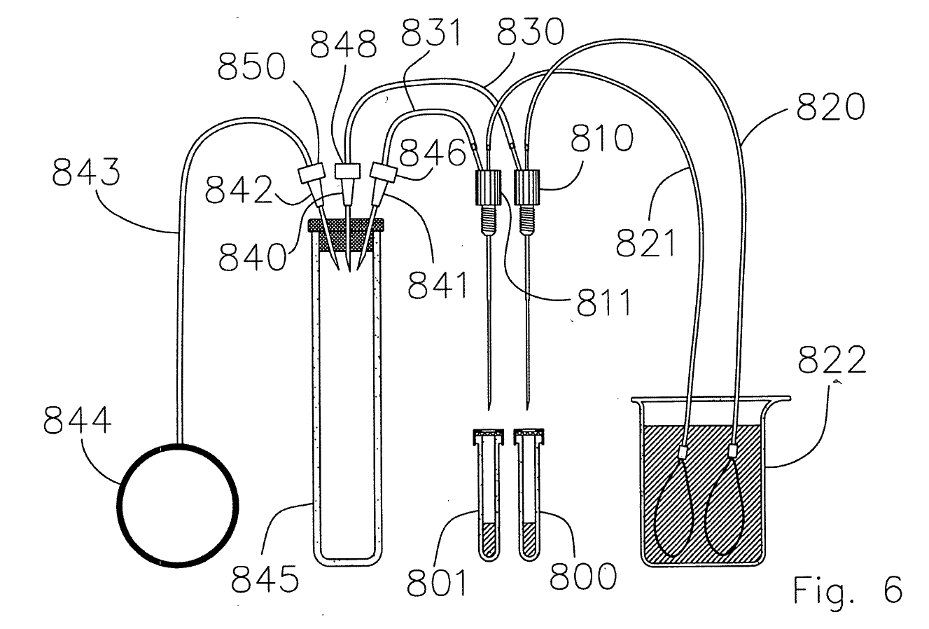

Referring now to FIG. 6, there is shown a partial cross-sectional view of another embodiment of the system of the present invention. In this embodiment, the system includes first and second collection vials 800 and 801, respectively. The system also includes first tube assembly 810 for collection of a first sample into first collection vial 800, and second tube assembly 811 for collection of a second sample into second collection vial 801. In this embodiment, first and second tube assemblies 810 and 811, respectively, are comprised of the components illustrated above in association with tube assembly 200 of FIG. 2 and FIG. 3.

The system of FIG. 6 further includes first probe 820 operably connected to the second end of the needle of first tube assembly 810, and second probe 821 operably connected to the second end of the needle of second tube assembly 811. Connected to the second end of the cannula of first tube assembly 810 is first tube 830, and connected to the second end of the cannula of second tube assembly 811 is second tube 831. First tube 830 is operably connected at its other end to first needle 840, and second tube 831 is operably connected at its other end to second needle 841. The system also includes third needle 842 having third tube 843 operably connected thereto, and third tube 843 is connected at its other end to vacuum source 844.

First, second, and third needles 840, 841, and 842, respectively, are inserted into trap 845. Trap 845 serves as a sealed manifold, as is explained in greater detail herein. In this embodiment, first, second and third needles 840, 841, and 842 comprise 16-gauge needles, and first, second, and third needles 840, 841, and 842 are operably connected to first, second, and third tubes 830, 831, and 843 by first, second, and third luer connectors 848, 846, and 850, respectively. Trap 845 comprises a manifold, and vacuum source 844 comprises a vacuum pump, such as a standard laboratory vacuum pump made by Gast Manufacturing of Benton Harbor, Mich.

To explain the method of ultrafiltrate collection according to one embodiment of the present invention, consider the system of FIG. 6 with only one tube assembly, namely, first tube assembly 810. First collection vial 800 is brought under first tube assembly 810. Dispensing tube assembly 810 is moved downward to allow the first end of the needle of first tube assembly 810 to pierce the septum of first collection vial 800 and the first end of the cannula of first tube assembly 810 to pierce the septum of first collection vial 810 so that the opening of the first end of the second tube resides within the interior of first collection vial 810. Activation of vacuum source 844 causes air (or other contents) within first collection vial 800 to be withdrawn by vacuum source 844. This withdrawal occurs by the vacuum created from vacuum source 844 through third tube 843, through needle 840, and through first tube 830. Ultrafiltrate fluid is then drawn through from the membrane of first probe 820 through needle 10 of first tube assembly 810 into first collection vial 800. The process of drawing of ultrafiltrate fluid continues as long as the needle of first tube assembly 810 is positioned within first collection vial 800.

When it is time to collect ultrafiltrate into another collection vial, first tube assembly 810 is moved up and out of first collection vial 800. A new collection vial (which contains air and/or other fluid inside) is brought under first tube assembly 810. The contents of the new collection vial are evacuated and ultrafiltrate is drawn into the new collection vial by the vacuum, as described above in connection with first collection vial 800. This process repeats for every sample collection desired.

Vacuum source 845 provides a constant level of vacuum so that the flow of ultrafiltrate is not affected by the vacuum source. Vacuum source 845 is sized to overcome small leaks in the system, including, any leaks through septum of the collection vial, and still provide consistent vacuum within the collection vial. It will be appreciated that the level of vacuum can be monitored and adjusted if desired. Monitoring of these factors improve the reliability of ultrafiltrate collection. Automation of sample collection is readily accomplished because any size collection vial may be used with the system of the present invention. Vacuum source 845 may also be sized to accommodate leakage of air into the collection vial. Therefore, collection vials with plastic caps, without septa, may be used. The use of plastic caps reduces cost and time spent sealing septa capped vials.

According to the present invention, vacuum source 844 is constantly drawing a vacuum, thereby creating a vacuum in the trap 845. When the tube assemblies of the present invention are up (out of the collection vial(s)), atmospheric air flows between first and second tubes of each tube assembly into trap 845, then out of trap 845 through third tube 843 through vacuum source 844. When the needles of the tube assemblies are down into the interiors of the collection vials, the vacuum in trap 845 draws air (contents) out of the collection vials as previously described. If the needles of the tube assemblies remain in the interior of the collection vials too long, the vial(s) will overfill and filtered fluid will flow through the interstitial space between first and second tubes of the tube assemblies, through the tube connecting the tube assembly to the needle attached to trap 845 into the trap 845 where the filtered fluid will fall to the bottom of trap 845. This trapping of filtered fluid prevents fluid from being drawn into vacuum source 844.

Using the system and method of the present invention, small volume ultrafiltrate samples may be collected in small collection vials, making the fluid samples easier to extract and allows a greater proportion of valuable sample to be extracted from the collection vial for processing and analysis. The ability to collect small samples is important because sometimes the analyte in solution is very dilute and sample volumes are limited when small animals are used. The greater the sample that can be removed to the collection vial, the easier it is to quantitate the analyte.

Sealed manifold 845 may comprise a standard vacutainer. Manifold 845 of this embodiment provides two functions. First, manifold 845 provides a trap for fluid if one of the collection vials 800 or 801 should overfill, thereby preventing fluid from entering vacuum source 844. Second, manifold 845 allows multiple tube assemblies, and therefore multiple ultrafiltration probes, to be connected to a single vacuum source, such as is illustrated in FIG. 6. In this manner, a single vacuum source may service any number of ultrafiltration probes simultaneously.

It will be appreciated by one of skill in the art that the ultrafiltration collection system of FIG. 6 may be included as part of an automated collection system. For example, first and second collection vials 800 and 801, and first and second tube assemblies 810 and 811 may be included with a fraction collector, such as is illustrated in FIG. 4. A control system may be operably connected to vacuum 844 and the fraction collector for control of the flow of fluids from probes 820 and 821, through tubes 830 and 831, and through tube 843.

One skilled in the art will recognize that the collection vials used for ultrafiltrate according to the present invention do not have to be septum sealed. A septum is not required if the vacuum pump is sized properly to accommodate small air leaks into the vial and if the operator is confident that the vial will not over flow with sample. Also, the ultrafiltrate system and method do not require a trap. Instead, the vacuum source may be operatively connected to the tube assembly. However, the trap may be useful for support of multiple probes and to prevent filtered fluid from reaching the vacuum source.

It will be appreciated by those of skill in the art that the system and method for collecting ultrafiltrate samples according to the present invention resolves many of the shortcomings of the prior art. The present invention is suitable for use in drawing small volume samples as it permits for control of the vacuum, even if leakages exists in the system, and also permits for control of the flow of fluid from the probe.

One skilled in the art will also recognize that the system and method described for ultrafiltrate collection is not limited to ultrafiltration. The system and method may be used to pull other types of sample into a collection vial by use of the vacuum source. For example, blood could be collected from a small subject. Thus, the term “probe” as used herein and in the claims is not limited to an ultrafiltration probe, but may comprise a catheter or other tubing.

It will be further appreciated that the system and method of the present invention do not require human intervention for ultrafiltration collection of multiple samples. In addition, the present invention may be used manually or retrofitted into existing automated systems for ultrafiltration collection.

It will be still further appreciated that the tubing of the ultrafiltration collection system of the present invention addresses several shortcomings associated with some prior art systems. The tubing used in the system of the present invention is not of large volume, and therefore does not result in a large time lag for low flow rates. Also, the tubing is not of a type to contaminate the fluid washing through the tube, nor does the tubing of the present invention have changing flow characteristics. Therefore, the system and method of the present invention provide for consistent flow over time.

As used herein and in the claims, the term “tainted” describes some level of mixture, but is not intended to imply a mixture having a minimal amount of a particular constituent. For example, when rinsing according to the method of the present invention, the rinse solution is “tainted” by the biological waste fluid at a level of waste fluid much lower than the level the rinse fluid is “tainted” with continued flow of the rinse solution toward the waste container.

As used herein and in the claims, the “contents” of the collection vial or rinse vial is meant to cover any and all types of contents. For example, rinse vials usually initially contain rinse solution, perhaps with some air in the rinse vial. After some rinsing according to the present invention, the rinse vial will contain a combination of rinse solution and biological waste. Collection vials usually initially contain air. However, a collection vial could also contain chemicals, such as chemicals used to stabilize or affect the sample collected. An example of such chemicals is anticoagulants used for blood samples to inhibit coagulation of the blood sample. Often, such chemicals are in powder form at the bottom of the vial, but it is possible that the chemical could be in fluid form as well.

The above-described embodiments of the present invention are intended to be examples only. Alterations, modifications and variations to the invention by those of skill in the art may be effected to the particular embodiments without departing from the scope of the invention, which is defined solely by the claims appended hereto.

1. A tube assembly, comprising:
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and first end of the second tube such that the first end of the first tube extends beyond the first end of the second tube, with the first end of the first tube inside the first end of the second tube creating an interstitial space about the first tube at the first end of the second tube; and
a first container operatively connected to the second end of the second tube, the first container for receipt of waste from the second tube.

2. The tube assembly of claim 1, wherein the first tube comprises a needle.

3. The tube assembly of claim 1, wherein the second tube comprises a cannula.

4. The tube assembly of claim 1, wherein the securing means comprises a threaded hub.

5. The tube assembly of claim 4, wherein the threaded hub forms a cavity.

6. The tube assembly of claim 5, wherein the securing means further comprises an adhesive within the cavity of the threaded hub.

7. A tube assembly, comprising:
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and the first end of the second tube such that the first end of the first tube extends beyond the first end of the second tube, with the first end of the first tube inside the first end of the second tube creating an interstitial space about the first tube at the first end of the second tube; and
a first container operatively connected to the second end of the second tube, the first container for receipt of waste from the second tube,
wherein the interstitial space allows for the flow of waste into the first container.

8. The tube assembly of claim 7, further comprising:
a second container operatively connected to the second end of the first tube, the second container for provision of a liquid from the first container through the first tube.

9. The tube assembly of claim 8, wherein the liquid comprises rinse solution.

10. The tube assembly of claim 8, wherein the liquid comprises biological fluid.

11. A tube assembly, comprising:
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and the first end of the second tube such that the first end of the first tube extends beyond the first end of the second tube, with the first tube inside the first end of the second tube creating an interstitial space about the first tube at the first end of the second tube;
a first container operatively connected to the second end of the first tube, the first container for provision of a liquid from the first container through the first tube;
a second container operatively connected to the second end of the second tube, the second container for receipt of waste from the second tube; and
a third container for operable connection to both the first end of the first tube and the first end of the second tube.

12. The tube assembly of claim 11, wherein
the liquid comprises a rinse solution; and
the third container holds a biological fluid.

13. The tube assembly of claim 11, wherein the third container comprises a vial.

14. A tube assembly, comprising:
a first tube having first and second ends, the first end of the first tube having an opening therein;
a second tube having a first end and a second end, the first end of the second tube being open and having a diameter greater than the diameter of the first end of the first tube;
a securing means operable to secure the first ends of both the first and second tubes such that the first end of the first tube extends beyond the first end of the second tube, with the first end of the first tube inside the first end of the second tube creating an interstitial space about the first tube at the first end of the second tube;
a first container for operable connection to both the first end of the first tube and the first end of the second tube; and
a second container operatively connected to the second end of the second tube, the first container for receipt of waste from the second tube.

15. The tube assembly of claim 14, wherein the first container comprises a vial.

16. The tube assembly of claim 15, wherein the vial comprises a septum.

17. The tube assembly of claim 16, wherein the vial further comprises a guide cap.

18. A system, comprising:
a tube assembly, the tube assembly including a first tube, a second tube, and a securing means, the first tube having first and second ends with the first end having an opening therein, the second tube having a first and second ends with the first end being open and having a diameter greater than the diameter of the first end of the first tube, and the securing means operable to secure the first ends of the first and second tubes such that the first end of the first tube extends beyond the first end of the second tube, with the first tube inside the first end of the second tube creating an interstitial space about the first tube at the first end of the second tube;
a first container operatively connected to the second end of the second tube for collection of waste therein;
a second container operatively connected to the second end of the first tube for provision of a first liquid through the first tube;
a third container operable for connection to both the first end of the first tube and the first end of the second tube; and
a position system for positioning the tube assembly over and into the third container to allow the first end of the first end tube and the first end of the second tube to enter the third container while the outside surface of the second tube proximate the first end of the second tube sealingly engages the third container such that the displacement of any of the contents of the third container is caused to flow through the interstitial space into the first container.

19. The system of claim 18, wherein the first liquid comprises a biological fluid sample, and wherein the third container is for collection of such biological sample.

20. The system of claim 18, wherein the first liquid comprises rinse solution, and wherein the third container is for collection of such rinse solution.

21. The system of claim 18, further comprising:
a fourth container operable for connection to both the first end of the first tube and the first end of the second tube, and
wherein the positioning system is further capable of positioning the tube assembly over and into the fourth container to allow the first end of the first tube and the first end of the second tube to enter the fourth container while the outside surface of the second tube proximate the first end of the second tube sealingly engages the fourth container such that this displacement of any of the contents of the fourth container is caused to flow through the interstitial space into the first container.

22. The system of claim 21, further comprising:
a fifth container operatively connected to the second end of the first tube for provision of a second liquid through the first tube; and
a valve connected to the second end of the first tube between the second end and each of the second and fifth containers, the valve operable to select whether the first liquid from the second container or the second liquid from the fifth container is to flow through the first tube,
wherein the first liquid comprises a biological sample and the third container is for collection of such biological fluid, and wherein the second fluid comprises a rinse solution and the fourth container is for collection of such rinse solution.

23. The system of claim 22, further comprising:
a controller operatively connected to the positioning system and to the valve for control of the positioning of the tube assembly over, into, and out of the third and fourth containers and for selection of the first and second liquids via the valve.

24. A method for waste containment, the method comprising the steps of:
providing a tube assembly, the tube assembly comprising
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and first end of the second tube such that the first end of the first tube extends beyond the first end of the second tube, with the first end of the first tube inside the first end of the second tube creating an interstitial space about the first tube at the first end of the second tube;
providing a first container operatively connected to the second end of the second tube, the first container for receipt of waste from the second tube;
providing a second container for operable connection to both the first end of the first tube and the first end of the second tube;
connecting the tube assembly to the second container such that the opening of the first end of the tube assembly and the first end of the second tube reside within the second container and the outside surface of the second tube proximate the first end of the second tube is sealingly engaged with the exterior of the second container;
sending a fluid from the second end of the first tube to the first end of the first tube into the second container; and
allowing the displaced contents of the second container to flow through the interstitial space of the tube assembly into the first container.

25. The method of claim 24, wherein the fluid comprises a biological sample and the displaced contents comprise air within the second container, such that the method operates to collect air tainted with the biological sample in the first container.

26. The method of claim 24, wherein the fluid comprises a rinse solution and the displaced contents comprise rinse solution within the second container, such that the method operates to collect rinse solution tainted with the biological sample in the first container.

27. The method of claim 26, further comprising the step of
continuing to send the fluid into the second container after all the initial contents of the second container have been displaced, such that the method operates to collect rinse solution tainted with the biological sample from the second container and rinse solution tainted with the biological sample from the interstitial space in the first container.

28. A method of waste containment, the method comprising the steps of:
providing a tube assembly, the tube assembly comprising
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and first end of the second tube such that the first end of the first tube extends beyond the first end of the second tube, with the first end of the first tube inside the first end of the second tube creating an interstitial space about the first tube at the first end of the second tube;
providing a first container operatively connected to the second end of the second tube, the first container for receipt of waste from the second tube;
providing a second container for operable connection to both the first end of the first tube and the first end of the second tube, the second container comprising a collection vial for collection of a biological sample, the collection vial further comprising a septum;
connecting the tube assembly to the second container such that the opening of the first end of the first tube and the first end of the second tube is inserted through the septum of the collection vial and resides within the interior of the collection vial and the outside surface of the second tube proximate the first end of the second tube is sealingly engaged with the septum of the collection vial;
sending the biological fluid from the second end of the first tube to the first end of the first tube into the second container; and
allowing the contents of the second container displaced by the biological fluid to flow through the interstitial space of the tube assembly into the first container.

29. The method of claim 28, wherein the fluid comprises a biological sample and the displaced contents comprise air within the second container, such that the method operates to collect air tainted with the biological sample in the first container.

30. The method of claim 29, further comprising the steps of:
providing a third container for operable connection to both the first end of the first tube and the first end of the second tube, the third container comprising a rinse vial for collection of a rinse solution, the rinse vial comprising a septum;
removing the tube assembly from operable connection to the collection vial;
connecting the tube assembly to the rinse vial such that the opening of the first end of the first tube and the first end of the second tube is inserted through the septum of the rinse-vial and resides within the interior of the rinse vial and the outside surface of the second tube proximate the first end of the second tube is sealingly engaged with the septum of the rinse vial;
sending the rinse from the second end of the first tube to the first end of the first tube into the third container; and
allowing the contents of the third container displaced by the rinse solution to flow through the interstitial space of the tube assembly into the first container.

31. The method of claim 30, further comprising the steps of:
continuing to send the rinse solution from the second end of the first tube to the first end of the first tube into the third container after all the initial contents of the third container have been displaced, such that the method operates to collect rinse solution tainted with the biological sample from the third container and rinse solution tainted with the biological sample from the interstitial space in the first container.

32. A method of waste containment, the method comprising the steps of:
providing a tube assembly, the tube assembly comprising
a first tube having first and second ends, the first end of the first tube having an opening therein;
a second tube having a first end and a second end, the first end of the second tube being open and having a diameter greater than the diameter of the first end of the first tube;
a securing means operable to secure the first end of the first tube and first end of the second tube such that the first end of the first tube extends beyond the first end of the second tube, with the first end of the first tube inside the first end of the second tube creating an interstitial space about the first tube at the first end of the second tube;
providing a first container operatively connected to the second end of the second tube, the first container for receipt of waste from the second tube;
providing a fraction collector onto which the tube assembly is mounted, the fraction collector comprising a collection vial for collection of a biological sample and a mechanism for orienting the tube assembly with respect to the collection vial, the collection vial further comprising a septum;
inserting with the fraction collector the tube assembly into the collection vial such that the opening of the first end of the first tube and the first end of the second tube is inserted through the septum of the collection vial and resides within the interior of the collection vial and the outside surface of the second tube proximate the first end of the second tube is sealingly engaged with the septum of the collection vial;
pumping a fluid from the second end of the first tube to the second end of the first tube into the second container; and
allowing the contents of the second container displaced by the fluid to flow through the interstitial space of the tube assembly into the first container.

33. The method of claim 32, wherein the fluid comprises a biological sample and the displaced contents comprise air within the second container, such that the method operates to collect air tainted with the biological sample in the first container.

34. The method of claim 32, wherein the fraction collector further comprises a rinse vial for collection of a rinse solution, the rinse vial comprising a septum, and wherein the fraction collector further includes a mechanism for orienting the tube assembly with respect to the rinse vial, the method further comprising the steps of:
removing with the fraction collector the tube assembly from operable connection to the collection vial;
connecting with the fraction collector the tube assembly to the rinse vial such that the opening of the first end of the first tube and the first end of the second tube is inserted through the septum of the rinse vial and resides within the interior of the rinse vial and the outside surface of the second tube proximate the first end of the second tube is sealingly engaged with the septum of the rinse vial;
pumping the rinse solution from the second end of the first tube to the second end of the first tube into the third container; and
allowing the contents of the third container displaced by the rinse solution to flow through the interstitial space of the tube assembly into the first container.

35. The method of claim 34, further comprising the steps of:
continuing to send the rinse solution from the second end of the first tube to the second end of the first tube into the third container after all the initial contents of the third container have been displaced, such that the method operates to collect rinse solution tainted with the biological sample from the third container and rinse solution tainted with the biological sample from the interstitial space in the first container.

36. The method of claim 32, further comprising a control system operatively connected to the fraction collector, the control system controlling the flow of fluid into the tube assembly according to predetermined volumes, such that the method does not require human intervention.

37. A system for sample collection, comprising:
a tube assembly having
first tube having first and second ends, the first end of the first tube having an opening therein,
a second tube having a first end and a second end, the first end of the second tube being open and having a diameter greater than the diameter of the first end of the first tube, and
a securing means operable to secure the first end of the first tube and the first end of the second tube such that the first end of the first tube extends beyond the first end of the second tube, with the first end of the first tube inside the first end of the second tube creating an interstitial space about the first tube at the first end of the second tube;
a probe operatively connected to the second end of the first tube of the tube assembly; and
a vacuum source operatively connected to the tube assembly.

38. The system of claim 37, further comprising:
a trap between and operatively connected to the second end of the second tube of the tube assembly and the vacuum source.

39. The system of claim 38, wherein the operative connection of the trap to the second end of the second tube of the tube assembly comprises:
a third tube having a first end and second end, the first end of the third tube connected to the second end of the second tube of the tube assembly; and
a needle having an opening and a distal end opposite the opening, the distal end of the needle connected to the second end of the third tube.

40. The system of claim 39, wherein the trap comprises a sealed manifold into which the opening of the needle is inserted.

41. The system of claim 38, wherein the trap comprises a vacutainer.

42. The system of claim 37, wherein the vacuum source comprises a vacuum pump.

43. The system of claim 38, wherein the operable connection of the vacuum source to the trap comprises a third tube.

44. The system of claim 37, further comprising:
a first container for collection of an ultrafiltration sample from the probe, the first container for connection to the tube assembly such that the first end of the first tube of the tube assembly and the first end of the second tube of the tube assembly reside within the interior of the first container.

45. A method of collecting a sample, comprising the steps of:
providing a tube assembly having
first tube having first and second ends, the first end of the first tube having an opening therein,
a second tube having a first end and a second end, the first end of the second tube being open and having a diameter greater than the diameter of the first end of the first tube, and
a securing means operable to secure the first end of the first tube and the first end of the second tube such that the first end of the first tube extends beyond the first end of the second tube, with the first end of the first tube inside the first end of the second tube creating an interstitial space about the first tube at the first end of the second tube;
providing a probe operatively connected to the second end of the first tube of the tube assembly, the probe in contact with the sample;
providing a vacuum source operatively connected to the second end of the second tube of the tube assembly;
providing a first container for collection of the sample from the probe, the first container for connection to the tube assembly such that the first end of the first tube of the tube assembly and the first end of the second tube of the tube assembly reside within the interior of the first container;
inserting the tube assembly into the first container; and
activating the vacuum source to cause air to withdraw from the first container through the second tube of the tube assembly and to pull the sample through the first tube of the tube assembly into the first container.

46. The method of claim 45, further comprising the step of:
providing a trap between and operatively connected to the second end of the second tube of the tube assembly and the vacuum source, and wherein the step of activating the vacuum source also causes the withdrawal of air from the trap.
